(19) United States
(12) Patent Application Publication
(10) Pub. No.: US 2011/0108439 A1
(43) Pub. Date: May 12, 2011

(54) OXIDE-ION SENSOR FOR USE IN A MOLTEN-SALT BASED ELECTROCHEMICAL REDUCTION PROCESS

(75) Inventors: Karthick Vilapakkam Gourishankar, Bangalore (IN); Andrew Maxwell Peter, Saratoga Springs, NY (US); Hari Nadathur Seshadri, Bangalore (IN); Anbarasan Viswanathan, Bangalore (IN)

(73) Assignee: GENERAL ELECTRIC COMPANY, SCHENECTADY, NY (US)

(21) Appl. No.: 12/614,470

(22) Filed: Nov. 9, 2009

(51) Int. Cl. G01N 27/26

(52) U.S. Cl. 205/789; 204/412

(57) ABSTRACT

An oxide-ion sensor includes an oxygen electrode, a sense electrode and a saturated (reference) electrode. The sense electrode is operated at a substantially constant current for determining an instantaneous value of a dissolved oxide-ion concentration in the molten salt electrolyte. The saturated electrode is used to determine a reference value of the dissolved oxide-ion concentration in the molten salt electrolyte. A dissolved oxide-ion concentration in the molten salt electrolyte is continuously monitored in-situ during the molten-salt based electrochemical reduction process by determining an equilibrium potential between the sense electrode and the saturated electrode with the sense electrode carrying a small current in a circuit that is completed using the oxygen electrode. In another embodiment, the dissolved oxide-ion concentration in the molten salt electrolyte is continuously monitored in-situ by determining an electrochemical impedance of the molten salt electrolyte using a pair of bare current-carrying conductors and a frequency response analyzer.

### BACKGROUND OF THE INVENTION

1. Field of the Invention

The invention is related to a sensor for an electrochemical process, and in particular to an oxide-ion sensor that can continuously monitor in-situ the dissolved oxide ion concentration during direct electrochemical reduction of oxides to metals in molten salts.

2. Description of the Related Art

Electrochemical processes have been used to recover high purity metal or metals from an impure feed. Electrochemical processes have also been used to extract metals from their ores, for example, metal-oxides. These processes typically rely on the dissolution of the metal or ore into the electrolyte and a subsequent electrolytic decomposition or selective electrotransport step. Thus, they require an electrolyte in which the metal-oxide of interest is soluble. In addition, the decomposition voltage of the electrolyte should be larger than that of the metal-oxide.

In those cases where the metal-oxide has a very low solubility in the electrolyte, the reduction of the metal-oxide is typically a two-step process requiring two separate process vessels. For example, in the extraction of uranium from spent nuclear fuel rods, the first step is a chemical reduction step at 650° C. using lithium dissolved in molten LiCl that produces uranium and Li₂O. The Li₂O dissolves in the molten LiCl. The second step is an electrowinning step, also at 650° C., where the dissolved Li₂O in the molten LiCl is electrolytically decomposed to regenerate lithium. The resulting lithium and LiCl salt with a low Li₂O concentration are then recycled to the reduction vessel for reduction of the next batch of oxide fuel.

U.S. Pat. No. 6,540,902 to Redey teaches that a dissolved oxide in the electrolyte is required to cathodically reduce a metal oxide, such as UO₂ and the like. The example is Li₂O in LiCl and the oxygen-ion species is dissolved in the electrolyte for transport to the anode, which is shrouded with a MgO tube to prevent back diffusion of oxygen.

During direct electrochemical reduction of oxides to metals in molten salts, it is important to continuously monitor in-situ the dissolved oxide ion concentration. A reliable apparatus and method for doing so is currently not available.

### BRIEF SUMMARY OF THE INVENTION

In one aspect of the invention, an oxide-ion sensor for use in a molten-salt based electrochemical reduction process comprises a sense electrode in contact with a molten salt electrolyte and operated at a substantially constant current for determining an instantaneous value of a dissolved oxide-ion concentration in the molten salt electrolyte; an oxygen electrode positioned proximate the sense electrode and in contact with the molten salt electrolyte and operated so as to maintain the substantially constant current on the sense electrode; and a saturated electrode in contact with the molten salt electrolyte for determining a reference value of the dissolved oxide-ion concentration in the molten salt electrolyte, wherein the oxide-ion sensor continuously monitors in-situ the dissolved oxide-ion concentration in the molten salt electrolyte during a molten-salt based electrochemical reduction process.

In another aspect of the invention, a process for monitoring in-situ dissolved oxide-ion concentration in a cell electrolyte during a molten-salt based electrochemical reduction process comprises the steps of:

determining an instantaneous value of a dissolved oxide-ion concentration in the molten salt electrolyte by operating a sense electrode in contact with a molten salt electrolyte at a substantially constant current;

positioning an oxygen electrode proximate the sense electrode and in contact with the molten salt electrolyte and operating the oxygen electrode so as to maintain the substantially constant current on the sense electrode; and

determining a reference value of the dissolved oxide-ion concentration in the molten salt electrolyte by using a saturated electrode in contact with the molten salt electrolyte,

whereby a dissolved oxide-ion concentration in the molten salt electrolyte is continuously monitored in-situ during the molten-salt based electrochemical reduction process by determining an equilibrium potential between the sense electrode and the saturated electrode.

In yet another aspect of the invention, an oxide-ion sensor for use in a molten-salt based electrochemical reduction process comprises a pair of electrodes, each electrode including a bare current carrying conductor separated from each other by a well defined geometry factor and inserted into the molten salt electrolyte at the spatial point of interest; and a potentiostat and a frequency response analyzer to provide an input perturbation signal and to measure an output impedance signal, wherein the oxide-ion sensor continuously monitors in-situ the dissolved oxide-ion concentration in the molten salt electrolyte during a molten-salt based electrochemical reduction process

In yet another aspect of the invention, a process for monitoring in-situ dissolved oxide-ion concentration in a molten salt electrolyte during a molten-salt based electrochemical reduction process, comprising the steps of:

positioning the pair of current carrying conductors with a well-defined and fixed geometrical factor in the molten salt electrolyte at the spatial point of interest;

applying an input signal to the pair of current-carrying conductors using a potentiostat and a frequency response analyzer; and

determining an instantaneous impedance of the molten salt electrolyte between the pair of current carrying conductors;

whereby a dissolved oxide-ion concentration in the molten salt electrolyte is continuously monitored in-situ during the molten-salt based electrochemical reduction process by determining an electrochemical impedance of the molten salt electrolyte between a pair of bare current carrying conductors using an arrangement of a potentiostat and a frequency response analyzer.

### BRIEF DESCRIPTION OF THE DRAWINGS

FIG. 1 is a schematic of an oxide-ion sensor according to an embodiment of the invention that determines the dissolved oxide-ion concentration in the molten salt electrolyte based on the concentration cell;

FIG. 2 is a graphical representation of the relationship between electrode potential and Li₂O concentration using the oxide-ion sensor of the invention;

FIG. 3 is a schematic of an oxide-ion sensor according to an alternate embodiment of the invention that determines the dissolved oxide-ion concentration in the molten salt electrolyte based on electrochemical impedance spectroscopy.

### DETAILED DESCRIPTION OF THE INVENTION

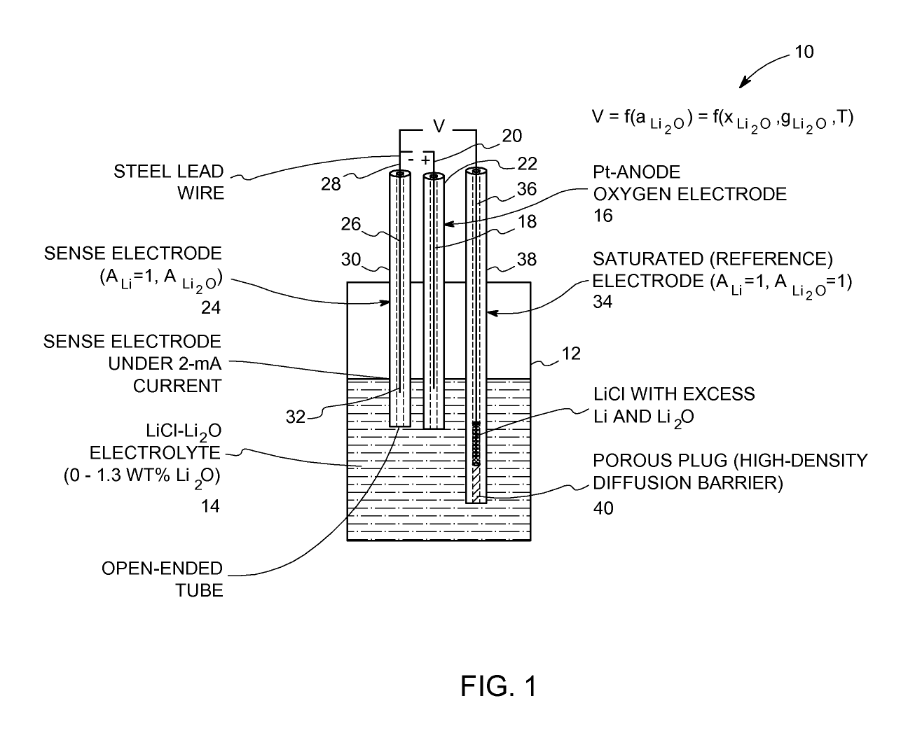

Referring now to FIG. 1, an oxide-ion sensor for use in a molten-salt based electrochemical process is shown generally at 10 according to an embodiment of the invention. The sensor 10 includes a crucible 12 made of an electrically insulated material, such as ceramic, high-density MgO, and the like. The crucible 12 can also be made of a metallic material that is coated with an electrically isolated material. An electrolyte 14 is contained within the crucible 12. The electrolyte 14 is an appropriate halide salt or mixture of halide salts containing a soluble oxide, for example, LiCl—Li₂O or CaCl₂—CaO. Fluoride salts can also be used. The choice of the electrolyte depends on the metal-oxide being reduced. For example, CaCl₂—CaO or CuF₂—CuCl₂—CuO, or some other suitable Ca-based electrolyte is preferred for the reduction of rare-earth oxides. In addition, the process temperature is dependent on the melting point of the electrolyte. As a result, the process temperature is about 200° C. higher for a CaCl₂—CaO electrolyte compared to a LiCl—Li₂O electrolyte. To lower the process temperature mixtures of halide salts such as low-melting eutectic LiCl—CaCl₂ containing soluble oxide ions may be used as the electrolyte. The presence of dissolved species of the metal of interest is not a requirement for this process. However, the electrolyte 14 should contain mobile oxide ions. The concentrations of the dissolved oxide species are controlled during the process by controlled additions of soluble oxides or chlorides by electrochemical or other means. In one embodiment, the electrolyte 14 comprises LiCl—Li₂O having 0-1.3 wt % Li₂O.

The sensor 10 includes an oxygen electrode, shown generally at 16, that may include a platinum or SnO₂ anode 18, or any other suitable non-consumable oxygen electrode. The non-consumable oxygen anode 18, also referred to as a dimensionally-stable anode, is chemically and dimensionally stable in the electrolyte environment of interest. An anode current lead 20 is inside an open-ended tube 22 made of a dense ceramic, such as MgO, and the like. The oxygen electrode 16 is operated as a counter electrode for maintaining a substantially constant current on a sense electrode 24, as described below.

However, in certain situations it may be necessary to exchange one anode for another during the reduction process. For example, when the oxide mixture consists of UO₂ and rare-earth oxides, the UO₂ can be reduced at relatively high dissolved oxide concentrations. However, the rare-earth oxide reduction is thermodynamically constrained and requires low dissolved oxide concentrations in the electrolyte. Further, at low dissolved oxide concentrations, it is likely that there will be co-evolution of chlorine along with oxygen at the anode. As a result, during this phase of the reduction it is necessary to work with anode materials that are stable in a chlorine gas environment as well as an oxygen gas environment. Examples of such anode materials include tin oxide and carbon/graphite. However, carbon/graphite is only a secondary choice at higher oxide concentrations because it is not stable, chemically and dimensionally, when oxygen gas is evolved vigorously. Thus, it may be necessary to implement a two-anode process, where initially an oxygen-stable anode such as Pt, SuO₂, LiFeO₂ or some other suitable mixed oxide (LiₓFe_{y}Ni_{(1-y)}O_{z}) is used at relatively high dissolved oxide concentrations, and subsequently to continue the reduction, a chlorine-stable anode, such as SnO₂ or carbon/graphite, is introduced in place of the oxygen-stable anode, and the reduction reaction continued at lower dissolved oxide concentrations in the electrolyte.

The sensor 10 includes a sense electrode, shown generally at 24, that may include a steel cathode 26, or any other suitable cathode material. A cathode current lead 28 is inside an open-ended tube 30 made of a dense ceramic, such as MgO, and the like, with the sensing tip 32 of the electrode 24 slightly retracted within the tube 30. Alternatively, the tube 30 may be plugged with a very porous frit to keep contaminants from entering the tube 30.

The sense electrode 24 is positioned in the electrolyte 14 such that only a small portion (a few millimeters) of the sensing tip 32 is contacting the electrolyte 14. The sense electrode 24 can be positioned at any desired location within the electrolyte 14. The sense electrode 24 is operated under a substantially constant low current to keep a layer of lithium metal continuously on the surface of the electrode. In one embodiment, the sense electrode 24 is maintained under a substantially constant low current of about 2 mA for determining an instantaneous value of a dissolved oxide-ion concentration in the molten salt electrolyte 14.

The sensor 10 also includes a saturated electrode or reference electrode, shown generally at 34. The saturated (reference) electrode 34 is used for determining a reference value of the dissolved oxide-ion concentration in the molten salt electrolyte 14. The construction of the reference electrode 34 depends on the electrolyte being used. For example, for the LiCl—Li₂O electrolyte system, the reference electrode 34 may consist of pure Li, or a suitable Li-alloy such as Sn—Li, or Ni/NiO, Fe/Fe₃O₄ in contact with the electrolyte 14. In one embodiment, the reference electrode 34 is packed with Li₂O powder that is at least five (5) times the required amount for saturation of electrolyte (LiCl) in the confined volume within the saturated electrode 34. The packing of the reference electrode 34 can be repeated whenever necessary to recharge the electrode to make up for any leakage losses over time. A metal or metal alloy electrode 36 is contained in a high-density MgO tube 38. A high-density diffusion barrier 40, such as a porous plug, at the end of the MgO tube 38 provides the connectivity between the reference electrode 34 and the electrolyte 14. In the reduction of PuO₂ or Nd₂O₃ in a CuCl₂—CaO electrolyte, the reference electrode may be Ca or a Ca alloy, or Ni/NO, Fe/Fe₂O₃, or other suitable stable electrode material.

As mentioned above, the current leads of the anode, the cathode, and the reference electrodes are electrically insulated from one another through the use of high-density MgO tubes around the electrodes. The MgO tubes around the electrodes are also used to prevent oxygen-induced corrosion in the melt and gas phases. The sensor 10 can be configured to include a stirrer in the electrolyte (not shown) to enhance mass transport of the dissolved oxide species. The cathode and anode are connected to external power sources as is well known in the art. Real-time data can be recorded using a data acquisition system and a computer. The data recorded includes the cell voltage (anode vs. cathode), the cell current, the potential of the anode vs. the reference electrode, the potential of the cathode vs. the other reference electrode, and the power source voltage.

In the operation of the sensor 10, a current-controlled electrochemical process is carried out in such a way that a desired electrochemically generated reducing potential is established at the sense electrode 24 at a suitable temperature where the salt is molten. Depending on electrolyte composition, the temperature may range from about 400° C. to about 1200° C. In one embodiment the temperature of the electrolyte 14 for an electrolyte composition of LiCl—Li₂O is about 650° C. The current source provides the reductant electrons. At the oxygen electrode 16, the oxide ion is converted to oxygen gas by the following reaction:

O²→½O₂+2e⁻

The sense electrode 24 is maintained under a constant low current as compared to the oxygen electrode 16 to keep a layer of lithium metal continuously on the surface of the electrode 24. In one embodiment, the sense electrode 24 is maintained under a constant low current of about 2 mA. The voltage between the sense electrode 24 and the saturated (reference) electrode 34 is measured continuously to follow changes in the electrolyte oxide-ion concentration. In other words, the oxide-ion sensor 10 of the invention continuously monitors in-situ the dissolved oxide-ion concentration in the molten salt electrolyte by determining an equilibrium potential between the sense electrode 24 and the saturated electrode 34. In this manner, the oxide-ion sensor 10 continuously monitors in-situ the dissolved oxide-ion concentration in the molten salt electrolyte 14 during a molten-salt based electrochemical reduction process.

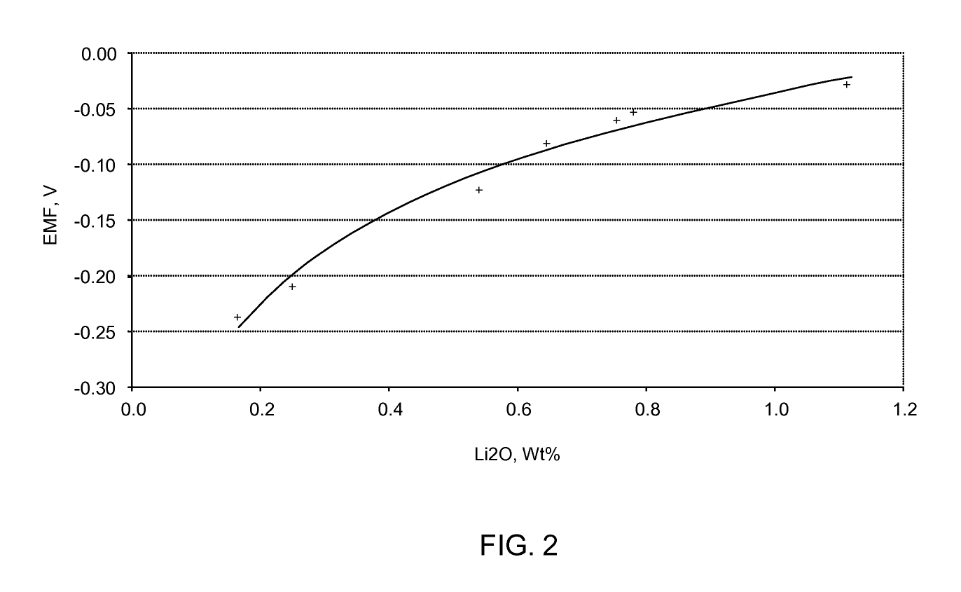

FIG. 2 illustrates a graph of the voltage between the sense electrode 24 and the saturated (reference) electrode 34 as a function of Li₂O concentration (wt %) for LiCl—Li₂O electrolyte at a melt temperature of about 650° C. As shown in FIG. 2, there is almost a 210 mV response from the oxide-ion sensor 10 for a Li₂O concentration in a range between about 0.2 wt % and 1.1 wt %, demonstrating a good sensitivity to Li₂O concentration.

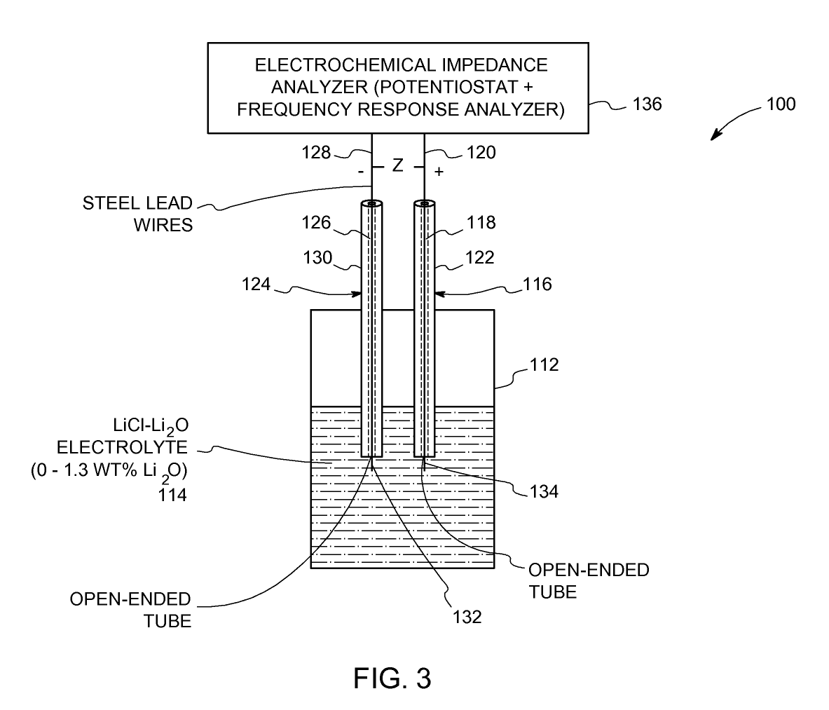

FIG. 3 illustrates an oxide-ion sensor 100 for use in a molten-salt based electrochemical process according to an alternate embodiment of the invention. In this embodiment, the dissolved oxide-ion concentration is determined by the oxide-ion sensor 100 based on an electrochemical impedance spectroscopy, rather than the dissolved oxide-ion concentration in the molten salt electrolyte 14 as in the embodiment shown in FIG. 1.

The sensor 100 includes a first electrode, shown generally at 116, that may include a bare current-carrying conductor 118, or any other suitable anode material. A steel lead wire 120 is inside an open-ended tube 122 made of a dense ceramic, such as MgO, and the like, with the sensing tip 134 of the electrode 116 slightly extending from the tube 122.

The sensor 100 also includes a second electrode, shown generally at 124, that may include a bare current-carrying conductor 126, or any other suitable cathode material. A steel lead wire 128 is inside an open-ended tube 130 made of a dense ceramic, such as MgO, and the like, with the sensing tip 132 of the electrode 124 slightly extending from the tube 130. The pair of bare current carrying conductors 118, 126 is fabricated with a well-defined and fixed geometrical factor (area exposed to molten salt electrolyte/distance between the two conductors). Thus, the second electrode 124 is separated from the first electrode 116 by a well defined geometry factor (area exposed to molten salt electrolyte/distance between the two conductors 118, 126).

The sensor 100 includes an electrochemical impedance analyzer, shown generally at 136 comprising a potentiostat and a frequency response analyzer. The potentiostat and frequency response analyzer 136 is electrically connected to each electrode 116, 124 to provide an input perturbation signal and to measure an output impedance signal of the sensor 100. The output impedance signal is measured instantaneously and continuously in the sensor 100. In one embodiment, the input perturbation signal is a sinusoidal current or voltage waveform with amplitude between about 2-100 mA (or about 2-100 mV) sweeping a frequency range between about 0.001 Hz to 10 MHz.

In operation, the pair of current carrying conductors 118, 126 is positioned in the molten salt electrolyte 14 at a spatial point of interest. An input signal is applied to the pair of current-carrying conductors 118, 126 using the potentiostat and frequency response analyzer 136, and the instantaneous impedance of the molten salt electrolyte 14 between the pair of current carrying conductors 118, 126 is determined. The dissolved oxide-ion concentration in the molten salt electrolyte is continuously monitored in-situ during the molten-salt based electrochemical reduction process by determining an electrochemical impedance of the molten salt electrolyte 114 between the pair of bare current-carrying electrodes 116, 124 using the frequency response analyzer 136.

Monitoring dissolved oxide ion concentration during the reduction process can yield several benefits: (1) the process can be controlled to ensure that harmful side reactions, such as chlorine evolution, do not occur at the anode that can lead to loss of electrode, (2) the termination of the reduction campaign can be better controlled so that the desired conversion from oxide to metal is repeatably achieved, (3) ability to monitor allows the reduction to be performed even with a lower starting oxide-ion concentration in the electrolyte, thus enhancing the reach of the process to include reduction of more refractory oxides and to produce lower levels of oxygen contamination in the final reduced product, (4) process upsets can be detected and corrected before catastrophic loss of expensive cell components, (5) an in-situ method of the invention is highly suitable for electrochemical reduction in hot cells requiring remote operations.

As described above, the sensor of the invention offers several technical advantages as compared to prior art sensors. One technical advantage is that the sensor of the invention includes the ability to continuously and spatially monitor an important parameter—dissolved oxide ion concentration—involved in the reduction process. Another technical advantage is that the sensor of the invention accrues from the ability to use the monitoring sensor as both a diagnostic, as well as, a process control tool. A commercial advantage of the sensor of the invention is that it provides a tool to improve the quality of the product and prevent unnecessary downtime.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An oxide-ion sensor for use in a molten-salt based electrochemical reduction process, the sensor comprising:
a sense electrode in contact with a molten salt electrolyte and operated at a substantially constant current for determining an instantaneous value of a dissolved oxide-ion concentration in the molten salt electrolyte;
an oxygen electrode positioned proximate the sense electrode and in contact with the molten salt electrolyte and operated so as to maintain the substantially constant current on the sense electrode; and
a saturated electrode in contact with the molten salt electrolyte for determining a reference value of the dissolved oxide-ion concentration in the molten salt electrolyte,
wherein the oxide-ion sensor continuously monitors in-situ the dissolved oxide-ion concentration in the molten salt electrolyte during a molten-salt based electrochemical reduction process.

2. The sensor according to claim 1, wherein the oxide-ion sensor continuously monitors in-situ the dissolved oxide-ion concentration in the molten salt electrolyte by determining an equilibrium potential between the sense electrode and the saturated electrode.

3. The sensor according to claim 1, wherein the substantially constant current is about 2 mA.

4. A process for monitoring in-situ dissolved oxide-ion concentration in a cell electrolyte during a molten-salt based electrochemical reduction process, comprising:
determining an instantaneous value of a dissolved oxide-ion concentration in the molten salt electrolyte by operating a sense electrode in contact with a molten salt electrolyte at a substantially constant current;
positioning an oxygen electrode proximate the sense electrode and in contact with the molten salt electrolyte and operating the oxygen electrode so as to maintain the substantially constant current on the sense electrode; and
determining a reference value of the dissolved oxide-ion concentration in the molten salt electrolyte by using a saturated electrode in contact with the molten salt electrolyte;
whereby a dissolved oxide-ion concentration in the molten salt electrolyte is continuously monitored in-situ during the molten-salt based electrochemical reduction process by determining an equilibrium potential between the sense electrode and the saturated electrode.

5. An oxide-ion sensor for use in a molten-salt based electrochemical reduction process, the sensor comprising:
a pair of electrodes, each electrode including a bare current carrying conductor separated from each other by a well defined geometry factor and inserted into a molten salt electrolyte at the spatial point of interest; and
a potentiostat and a frequency response analyzer to provide an input perturbation signal and to measure an output impedance signal,
wherein the oxide-ion sensor continuously monitors in-situ the dissolved oxide-ion concentration in the molten salt electrolyte during a molten-salt based electrochemical reduction process.

6. The sensor according to claim 5, wherein the oxide-ion sensor continuously monitors in-situ the dissolved oxide-ion concentration in the molten salt electrolyte by determining an electrochemical impedance of the molten salt electrolyte between the two bare current carrying electrodes.

7. The sensor according to claim 6, wherein the input perturbation signal comprises a sinusoidal current or voltage waveform with an amplitude between 2-100 mA or 2-100 mV sweeping a frequency range between 0.001 Hz to 10 MHz.

8. A process for monitoring in-situ dissolved oxide-ion concentration in a molten salt electrolyte during a molten-salt based electrochemical reduction process, comprising the steps of:
positioning a pair of current carrying conductors with a well-defined and fixed geometrical factor in the molten salt electrolyte at the spatial point of interest;
applying an input signal to the pair of current-carrying conductors using a potentiostat and a frequency response analyzer; and
determining an instantaneous impedance of the molten salt electrolyte between the pair of current carrying conductors;
whereby a dissolved oxide-ion concentration in the molten salt electrolyte is continuously monitored in-situ during the molten-salt based electrochemical reduction process by determining an electrochemical impedance of the molten salt electrolyte between the pair of bare current carrying conductors using an arrangement of a potentiostat and a frequency response analyzer.
